(19) United States
(12) Patent Application Publication
(10) Pub. No.: US 2015/0013924 A1
(43) Pub. Date: Jan. 15, 2015

(54) DECORATION PAINTING FOR FACILITATING DISMOUNTING TRANSPORT AND REPLACEMENT OF CANVAS

(71) Applicant: Hangzhou Classic-Maxim Arts & Crafts Co., Ltd., Hangzhou (CN)

(72) Inventor: Yun Luo, Hangzhou (CN)

(21) Appl. No.: 14/220,729

(22) Filed: Mar. 20, 2014

Related U.S. Application Data
(60) Provisional application No. 61/846,516, filed on Jul. 15, 2013.

(51) Int. Cl. B44D 3/18

(52) U.S. Cl. CPC B44D 3/185
USPC 160/378

(57) ABSTRACT

A decoration painting for facilitating the dismounting transport and the replacement of the canvas comprising a frame, a canvas and an elastic part, and the frame includes four borders which are detachably connected with each other, at least two rivet holes are uniformly distributed around the canvas which is covering on the body of the frame, the elastic part is connected with the two corresponding rivet holes. The decoration painting according to the present invention facilitates the disassembly and assembly department and the transport, and the canvas of the same size could be replaced as required, thus improving the utility while reducing the cost.

### TECHNICAL FIELD

The present invention relates to a decoration painting and a manufacturing method thereof, and especially relates to a decoration painting and its manufacturing method which can facilitate the dismounting transport, while saving the transport space and the storage space and facilitating the replacement of the canvas.

### BACKGROUND OF THE INVENTION

Nowadays, the decoration painting has already been widely used as a top grade domestic indoor or outdoor ornamental, whose images may be the landscape, the portrait or the nonobjectivism and so on, and may be harmonized with the corresponding indoor or outdoor environment, thus presenting the superior artistic value and increasing the whole aesthetic appearance effect of the indoor or outdoor environment. Therefore, the decoration painting is increasingly popular.

The decoration painting in the art generally comprises a frame and canvas which is always directly and rigidly mounted on the frame by the corporations. Due to the larger image area, the space occupied by the larger decoration painting is large when transporting and storing, thus bringing in much inconvenience for the transport and the storage. When transported into the decoration field, the decoration painting with the larger image area could not be transported into it due to the limitation of the size of the door and the windows.

### SUMMARY OF THE INVENTION

An object of the present invention is to provide a decoration painting for facilitating the dismounting transport and the replacement of the canvas differed from the traditional manufacturing methods with respect to the aforesaid technical drawbacks.

The technical solution employed in the present invention is as follow:

A decoration painting for facilitating the dismounting transport and the replacement of the canvas, the character is that it comprises a frame, canvas and an elastic part, and the frame includes four borders which are detachably connected with each other, at least two rivet holes are uniformly distributed around the canvas which is covering on the body of the frame, the elastic part is connected with the two corresponding rivet holes.

At least two straight pieces are secured on the said canvas, several rivet holes are uniformly distributed on the straight pieces, the rivet holes on the straight piece are coincided with the rivet holes on the canvas and the length of the straight pieces are no more than the length of the corresponding borders.

A ferrule is riveted on the rivet hole of said canvas.

Said elastic part is made of the metal with ductility, the plastic, the cloth or the rubber.

Preferably, said elastic part is a spring or a rubber band.

Said straight piece is made of the rigid material.

Said straight piece is made of the metal, the rigid plastic, the wood, or the bamboo.

Preferably, said straight piece is made of the iron or the stainless steel.

The advantageous effect of the present invention is as follow:

The decoration painting according to the present invention is differed from the traditional manufacturing method. In the decoration painting according to the present invention, the frame which comprises detachable borders is separated from the canvas which can be wounded, as compared with the traditional decoration painting directly mounted on the canvas, thus greatly reducing the occupied space when transporting and storing, and the surface of the canvas may not be easily damaged because of the press. In use, the borders of the frame are fixed by means of the manual tools, and the canvas covers one side of the frame and is tighten by the elasticity of the elastic part, thus making the front side of the canvas smooth.

When the decoration painting of the present invention is transported or stored, the borders of the frame, the fixed part of the borders, the canvas and the elastic part are transported or stored separately, thus greatly reducing the space and the cost that can be convenient to dispose in all kinds of locations. Moreover, the canvas of the same size could be replaced as required, in order to adapt to the requirement of the different environments.

### BRIEF DESCRIPTION OF THE DRAWINGS

FIG. 1 is the schematic structural back view of the body according to the present invention.

FIG. 2 is the schematic view of the connection between the corresponding two rivet holes on the canvas according to the present invention.

FIG. 3 is the schematic view of another connection between the corresponding rivet holes on the canvas according to the present invention.

Wherein: 1-a canvas; 2-a rivet hole; 21-a ferrule; 3-an elastic part; 31-a hook; 4-a frame; 5-a straight piece

### DETAIL DESCRIPTION OF THE INVENTION

In the following, the present invention will be explained in detail with respect to the preferred embodiments. It should be understood, however, that the following embodiments are only examples for the purpose of illustrating the spirit of the invention rather than limiting the scope of the present invention. Any modifications or indiscriminate application in accordance with said embodiments should fall into the scope of the technical solution according to the present invention.

### The First Example

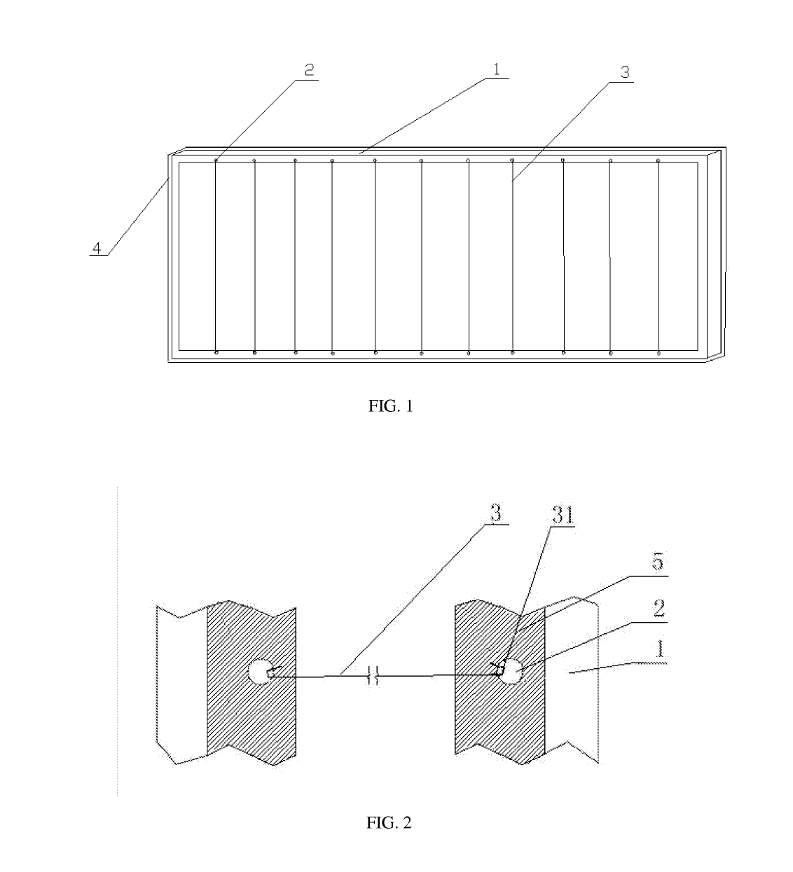

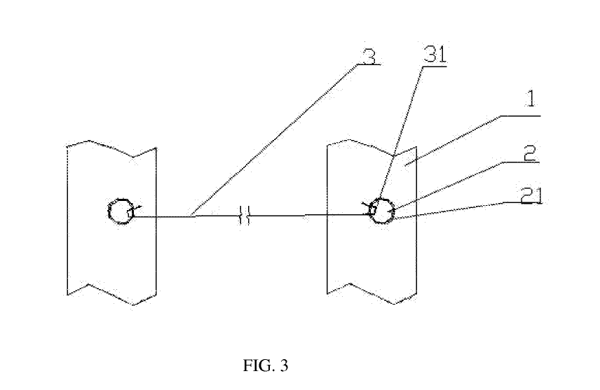

A decoration painting for facilitating the dismounting transport and the replacement of the canvas shown in FIGS. 1-3 is consisted of a frame (4) and a canvas (1) which is of rectangle. The edges of the canvas are folded up and then sewn up, and the width of the folded canvas is suitable for inserting a straight piece (5). Four rivet holes (2) are uniformly distributed on the long sides of the canvas and the straight piece (5), while two rivet holes (2) are uniformly distributed on the short sides of the canvas and the straight piece (5). The straight piece made of the stainless steel material is inserted at the suture of the canvas edges, and the frame is covered by the canvas. The two corresponding rivet holes on the canvas and the straight piece are connected by means of an elastic part (3) with hooks on the both ends, and the said elastic part is a strong rubber band.

### The Second Example

A decoration painting for facilitating the dismounting transport and the replacement of the canvas shown in FIGS. 1-3 is consisted of a frame (4) and a canvas (1) which is of rectangle. Four rivet holes (2) are uniformly distributed on the long sides of the canvas, while two rivet holes (2) are uniformly distributed on the short sides of the canvas. A ferrule (21) is riveted on the rivet holes and the frame is covered by the canvas. Two corresponding rivet holes on the canvas are connected by an elastic part (3) with hooks on the both ends, and the said elastic part is a strong rubber band.

### The Third Example

A decoration painting for facilitating the dismounting transport and the replacement of the canvas shown in FIGS. 1-3 is consisted of a frame (4) and a canvas (1) which is of square. The edges of the canvas are folded up and then sewn up, and the width of the folded canvas is suitable for inserting a straight piece (5). Two rivet holes (2) are uniformly distributed on the four sides of the canvas and the straight piece (5). The straight piece made of the stainless steel material is inserted at the suture of the canvas edges, and the frame is covered by the canvas. The two corresponding rivet holes on the canvas and the straight piece are connected by the elastic part (3) with hooks on the both ends and the said elastic part is a strong rubber band.

### The Forth Example

A decoration painting for facilitating the dismounting transport and the replacement of the canvas shown in FIGS. 1-3 is consisted of a frame (4) and a canvas (1) which is of circular shape. Eight rivet holes (2) are uniformly distributed around the canvas. A ferrule (21) is riveted on the rivet holes and the frame is covered by the canvas. The two corresponding rivet holes on the canvas are connected by the elastic part (3) with hooks on the both ends, and the said elastic part is a strong rubber band.

### The Fifth Example

A decoration painting for facilitating the dismounting transport and the replacement of the canvas shown in FIGS. 1-3 is consisted of a frame (4) and a canvas (1) which is of rectangle The edges of the canvas are folded up and then sewn up and the width of the folded canvas is suitable for inserting a straight piece (5). Two rivet holes (2) are uniformly distributed on the long sides of the canvas and the straight piece (5), while two rivet holes (2) are uniformly distributed on the short sides of the canvas and the straight piece (5). The straight piece made of the stainless steel material is inserted at the suture of the canvas edges, and the frame is covered by the canvas. The two corresponding rivet holes on the canvas and the straight piece are connected by means of an elastic part (3) with hooks on the both ends, and the said elastic part is a strong rubber band.

### The Sixth Example

A decoration painting for facilitating the dismounting transport and the replacement of the canvas shown in FIGS. 1-3 is consisted of a frame (4) and a canvas (1) which is of rectangle. The edges of the canvas are folded up and then sewn up, and the width of the folded canvas is suitable for inserting a straight piece (5). Four rivet holes (2) are uniformly distributed on the long sides of the canvas and the straight piece (5), while two rivet holes (2) are uniformly distributed on the short sides of the canvas and the straight piece (5). The straight piece made of wood is inserted at the suture of the canvas edges, and the frame is covered by the canvas. The two corresponding rivet holes on the canvas and the straight piece are connected by means of an elastic part (3) with hooks on the both ends, and the said elastic part is a strong rubber band.

### The Seventh Example

A decoration painting for facilitating the dismounting transport and the replacement of the canvas shown in FIGS. 1-3 is consisted of a frame (4) and a canvas (1) which is of rectangle. The edges of the canvas are folded up and then sewn up, and the width of the folded canvas is suitable for inserting a straight piece (5). Four rivet holes (2) are uniformly distributed on the long sides of the canvas and the straight piece (5), while two rivet holes (2) are uniformly distributed on the short sides of the canvas and the straight piece (5). The straight piece made of iron is inserted at the suture of the canvas edges, and the frame is covered by the canvas. The two corresponding rivet holes on the canvas and the straight piece are connected by means of an elastic part (3) with hooks on the both ends, and the said elastic part is a strong rubber band.

### The Eighth Example

A decoration painting for facilitating the dismounting transport and the replacement of the canvas shown in FIGS. 1-3 is consisted of a frame (4) and a canvas (1) which is of rectangle. The edges of the canvas are folded up and then sewn up, and the width of the folded canvas is suitable for inserting a straight piece (5). Four rivet holes (2) are uniformly distributed on the long sides of the canvas and the straight piece (5), while two rivet holes (2) are uniformly distributed on the short sides of the canvas and the straight piece (5). The straight piece made of the rigid plastic material is inserted at the suture of the canvas edges, and the frame is covered by the canvas. The two corresponding rivet holes on the canvas and the straight piece are connected by means of an elastic part (3) with hooks on the both ends, and the said elastic part is a strong rubber band.

### The Ninth Example

A decoration painting for facilitating the dismounting transport and the replacement of the canvas shown in FIGS. 1-3 is consisted of a frame (4) and a canvas (1) which is of rectangle. The edges of the canvas are folded up and then sewn up, and the width of the folded canvas is suitable for inserting a straight piece (5). Four rivet holes (2) are uniformly distributed on the long sides of the canvas and the straight piece (5), while two rivet holes (2) are uniformly distributed on the short sides of the canvas and the straight piece (5). The straight piece made of the stainless steel material is inserted at the suture of the canvas edges, and the frame is covered by the canvas. The two corresponding rivet holes on the canvas and the straight piece are connected by means of an elastic part (3) with hooks on the both ends, and the said elastic part is a spring.

### The Tenth Example

A decoration painting for facilitating the dismounting transport and the replacement of the canvas shown in FIGS. 1-3 is consisted of a frame (4) and a canvas (1) which is of rectangle Four rivet holes (2) are uniformly distributed on the long sides of the canvas, while two rivet holes (2) are uniformly distributed on the short sides of the canvas. A ferrule (21) is riveted on the rivet holes and the frame is covered by the canvas. Two corresponding rivet holes on the canvas are connected by means of an elastic part (3) with hooks on both the ends, and the said elastic part is a spring.

### The Eleventh Example

A decoration painting for facilitating the dismounting transport and the replacement of the canvas is shown in FIGS. 1-3 is consisted of a frame (4) and a canvas (1) which is of rectangle. The straight piece (5) made of the stainless steel material is bonded to the canvas edges by means of the adhesive. Four rivet holes (2) are uniformly distributed on the long sides of the canvas and the straight piece (5), while two rivet holes (2) are uniformly distributed on the short side of the canvas and the straight piece (5). The frame is covered by the canvas. The two corresponding rive holes on the canvas and the straight piece are connected by means of an elastic part (3) with hooks on the both ends, and the said elastic part is a strong rubber band.

1. A decoration painting for facilitating the dismounting transport and the replacement of the canvas, the character is that it comprises a frame, a canvas and an elastic part, and the frame includes four borders detachably connected with each other, at least two rivet holes are uniformly distributed around the canvas covering on the body of the frame, and the elastic part is connected with the two corresponding rivet holes.

2. The decoration painting for facilitating the dismounting transport and the replacement of the canvas according to claim 1, the character is that at least two straight pieces are secured on the said canvas, several rivet holes are uniformly distributed on the straight pieces, the rivet holes on the straight piece are coincided with the rivet holes on the canvas and the length of the straight pieces are no more than the length of the corresponding borders.

3. The decoration painting for facilitating the dismounting transport and the replacement of the canvas according to claim 1, the character is that a ferrule is riveted on the rivet hole of the said canvas.

4. The decoration painting for facilitating the dismounting transport and the replacement of the canvas according to claim 1, the character is that the said elastic part is made of the metal with ductility, the plastic, the cloth or the rubber.

5. The decoration painting for facilitating the dismounting transport and the replacement of the canvas according to claim 4, the character is that the said elastic part is a spring or a rubber band.

6. The decoration painting for facilitating the dismounting transport and the replacement of the canvas according to claim 2, the character is that the said straight piece is made of the rigid material.

7. The decoration painting for facilitating the dismounting transport and the replacement of the canvas according to claim 6, the character is that the said straight piece is made of the metal, the rigid plastic, the wood, or the bamboo.

8. The decoration painting for facilitating the dismounting transport and the replacement of the canvas according to claim 7, the character is that the said straight piece is made of the iron or the stainless steel.
